(19) United States
(12) Patent Application Publication
(10) Pub. No.: US 2015/0202718 A1
(43) Pub. Date: Jul. 23, 2015

(54) SUPPRESSING LASER-INDUCED PLUME FOR LASER EDGE WELDING OF ZINC COATED STEELS

(71) Applicant: GM GLOBAL TECHNOLOGY OPERATIONS LLC, Detroit, MI (US)

(72) Inventors: David Yang, Shanghai (CN); David A. Gatny, Sterling Heights, MI (US); Blair E. Carlson, Ann Arbor, MI (US); Jeff Wang, Nanjing Jiangsu (CN)

(73) Assignee: GM GLOBAL TECHNOLOGY OPERATIONS LLC, Detroit, MI (US)

(21) Appl. No.: 14/162,500

(22) Filed: Jan. 23, 2014

(51) Int. Cl. B23K 26/14; B23K 26/32

(52) U.S. Cl. CPC B23K 26/1405; B23K 26/3293

(57) ABSTRACT

A system and method for stabilizing the molten pool in a laser welding operation by suppressing a laser-induced plume which occurs when zinc coated steels are laser welded. The plume is a result of vaporization of zinc, and the zinc vapor in the plume disturbs the molten pool and causes blowholes, spattering and porosity. The stabilization is achieved by applying a gas such as air through a nozzle to the weld area, where the gas has sufficient velocity and flow rate to blow the zinc vapor away from the molten pool. Dramatically improved weld quality results have been demonstrated. Configuration parameters which yield optimum results—including gas flow rate and velocity, and nozzle position and orientation relative to the laser impingement location on the steel—are disclosed.

### BACKGROUND OF THE INVENTION

1. Field of the Invention

This invention relates generally to improving weld quality in laser welding operations and, more particularly, to a system and method for stabilizing the molten pool by suppressing a laser-induced plume which occurs when zinc coated steels are laser welded, where the stabilization is achieved by applying a gas from a nozzle to the weld area and the gas is applied with sufficient velocity and mass flow rate to dissipate the plume.

2. Description of the Related Art

Zinc coated steels are widely used in the automotive industry and other industries where resistance to rusting is important. For example, automobiles commonly use zinc coated steel for roofs, body side panels, door frames, floor pans, and other components.

Most cars and trucks are comprised of numerous structural and body panels which are brazed or welded together. Welding is preferred over brazing because welding can typically be performed faster and less expensively. At the same time, modern vehicle assembly operations make extensive use of laser welding due to the speed, economy and repeatability of laser welding equipment. However, when laser welding zinc coated steels, a problem arises which affects the quality of the finished product. The problem is that the zinc coating on the steel vaporizes during welding, and the zinc vapor disturbs the molten metal pool in the weld area. Specifically, the zinc vapor can cause blowholes and porosity in the weld itself, and spattering in the area around the weld.

Known solutions to the weld quality problem have their own drawbacks. For example, brazing the zinc coated steel instead of welding it adds cost to the operation and reduces throughput. Similarly, creating an environment of inert gas in the weld area also adds cost. A solution is needed which does not suffer from these drawbacks.

### SUMMARY OF THE INVENTION

In accordance with the teachings of the present invention, a system and method are disclosed for stabilizing the molten pool in a laser welding operation by suppressing a laser-induced plume which occurs when zinc coated steels are laser welded. The plume is a result of vaporization of zinc, and the zinc vapor in the plume disturbs the molten pool and causes blowholes, spattering and porosity. The stabilization is achieved by applying a gas such as air through a nozzle to the weld area, where the gas has sufficient velocity and flow rate to blow the zinc vapor away from the molten pool. Dramatically improved weld quality results have been demonstrated. Configuration parameters which yield optimum results—including gas flow rate and velocity, and nozzle position and orientation relative to the laser impingement location on the steel—are disclosed.

Additional features of the present invention will become apparent from the following description and appended claims, taken in conjunction with the accompanying drawings.

### BRIEF DESCRIPTION OF THE DRAWINGS

FIG. 1 is an illustration of a typical laser welding system;

FIG. 2A is a top view of a weld area which shows problems with the weld including blowholes and spatter;

FIG. 2B is a cross-section of a weld area which shows porosity, which is another problem with the weld;

FIG. 3 is a side-view illustration of a weld in progress, showing a plume of zinc vapor above the molten pool of the weld;

FIG. 4 is a side-view illustration of a welding system which includes a nozzle to supply a gas which suppresses the laser-induced plume and stabilizes the molten pool;

FIG. 5 is a simplified side-view illustration of the welding system of FIG. 4;

FIG. 6 is a simplified end-view illustration of the welding system of FIG. 4;

FIG. 7 is a simplified top-view illustration of the welding system of FIG. 4; and

FIG. 8 is a flowchart diagram of a method for welding zinc coated steel which includes applying a flow of gas to the weld area to suppress the fumes and stabilize the molten pool.

### DETAILED DESCRIPTION OF THE EMBODIMENTS

The following discussion of the embodiments of the invention directed to a system and method for suppressing laser-induced plume for laser edge welding of zinc coated steels is merely exemplary in nature, and is in no way intended to limit the invention or its applications or uses.

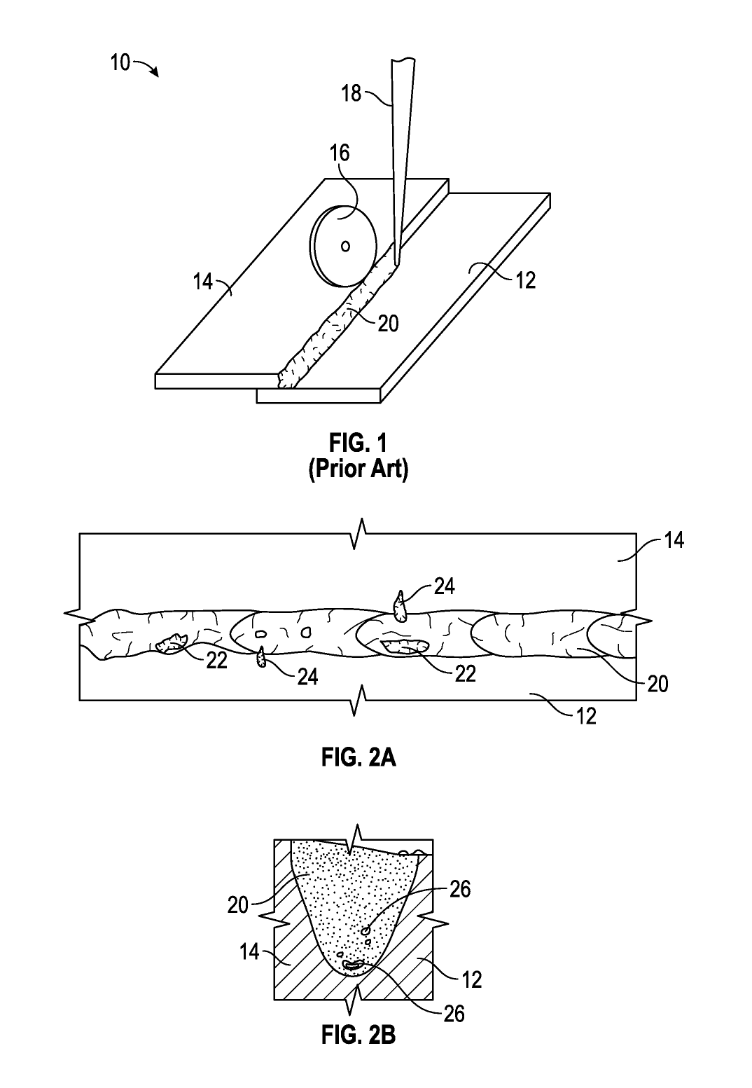

FIG. 1 is an illustration of a typical laser welding system 10 in which a first work piece 12 and a second work piece 14 are welded together. The system 10 includes a roller 16 which presses the second work piece 14 down onto the first work piece 12 as a laser beam 18 welds the work pieces 12 and 14 together. The speed of movement of the roller 16 and the laser beam 18 relative to the stationary work pieces 12 and 14, along with the energy level of the laser beam 18, are established to provide a weld area 20 which meets the requirements for joining the work pieces 12 and 14.

The laser welding system 10 works fine for many purposes. However, in some applications, such as when welding zinc coated sheets, problems arise with simple welding systems such as the system 10. FIG. 2A is a top view of the weld area 20 which shows problems with the weld quality including blowholes 22 and spatter 24. The blowholes 22 are literally holes or pockets in the weld area 20 where molten weld material blew out due to gas expansion in the molten weld material. The blowholes 22 can compromise the structural integrity and strength of the weld area 20, and thus are to be avoided if at all possible. The blowholes 22 also create a surface aesthetic quality problem, and may require re-finishing treatments such as touch-up welding and extra grinding and sanding.

The spatter 24 is a hardened blob of weld material, on or alongside the weld area 20, which consists of the weld material ejected from one of the blowholes 22. The spatter 24 also creates a surface aesthetic quality problem, and requires re-finishing treatments such as extra grinding and sanding.

FIG. 2B is a cross-section of the weld area 20 which shows porosity 26, which is another problem which can arise with weld quality from the system 10 when welding zinc coated sheets. The porosity 26 occurs where gaseous bubbles in the molten weld material become holes or voids in the weld area 20 when solidified. The porosity 26 can compromise the structural integrity and strength of the weld area 20, and thus is also to be avoided if at all possible.

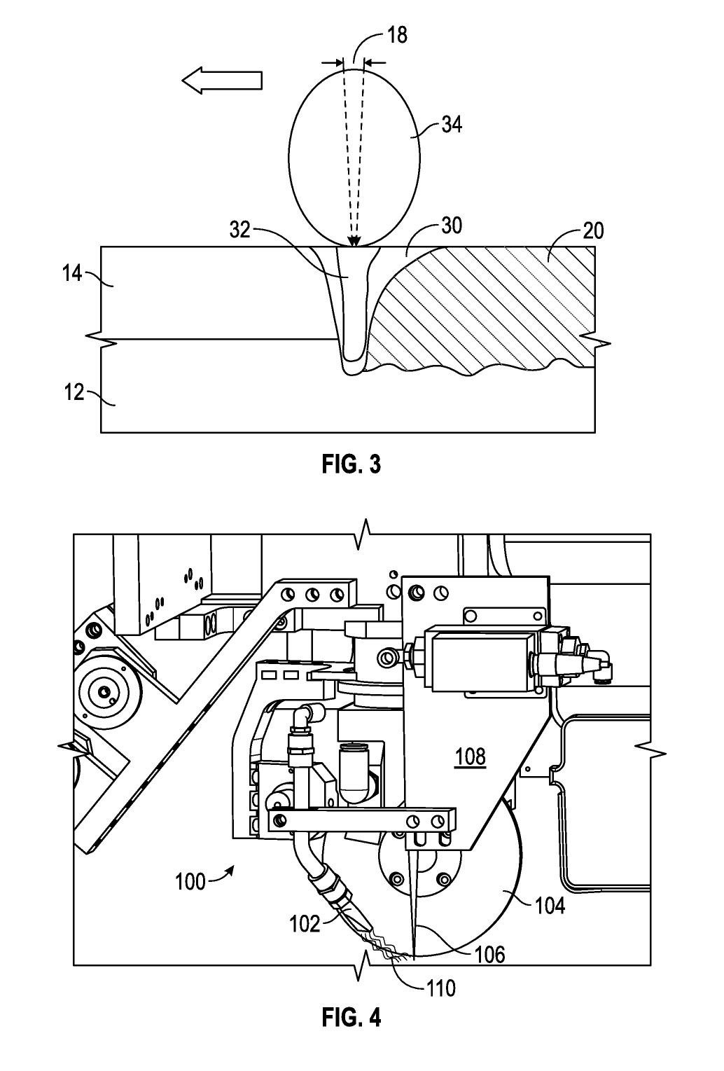

FIG. 3 is a side-view illustration of a weld in progress in a conventional welding operation such as on the system 10 of FIG. 1. The first work piece 12, the second work piece 14 and the weld area 20 were described above. A molten pool 30 exists in an area surrounding and recently heated by the laser beam 18, where the weld material is still above its melting temperature and is therefore in a liquid state. A keyhole 32 is the hottest part of the molten pool 30, which is actually being heated by the laser beam 18. A plasma and vapor plume 34 is present in a space above the molten pool 30 and the keyhole 32. In the case where zinc coated sheets are being welded, the plasma and vapor plume 34 contains zinc vapor which can react with the liquid weld material in the molten pool 30.

Zinc coated steel sheets are widely used in automotive body panel applications because of the corrosion protection provided by the zinc coating. It is therefore desirable to use zinc coated sheets but minimize or eliminate the blowholes 22, the spatter 24 and the porosity 26 described above. One way to eliminate these problems is to braze the metal sheets together rather than weld them. However, brazing is more expensive than welding, due to the added cost of the brazing wire and other factors. Another way to reduce the severity of these problems is to use a single sided zinc coating for the top sheet (the second work piece 14), in order to minimize the amount of zinc which is contained in the molten pool 30. However, a single sided zinc coating is only possible with electro-galvanized sheet steel, and this carries a price premium which makes it undesirable. Spot welding of steel sheets is another alternative, but spot welding is slow, and it requires a greater flange width in the sheet metal, thus reducing design flexibility and adding weight.

In order to weld conventional zinc coated sheets and avoid the blowhole, spatter and porosity problems, it is necessary to stabilize the keyhole 32 and the molten pool 30 by suppressing the laser-induced plasma and vapor plume 34. This stabilization can be achieved by using a nozzle which is integrated with the laser system to deliver a relatively high velocity flow of a shielding gas. Unlike other known systems which use expensive gases to create an inert environment around the weld area 20, the shielding gas as disclosed herein serves to move the plasma and vapor plume 34 away from the weld area 20 before the zinc vapor can react with the molten pool 30 and cause the blowhole, spatter and porosity problems described above.

FIG. 4 is a side-view illustration of a welding system 100 which overcomes the problems with laser welding of zinc coated steel described above. The system 100 includes a nozzle 102 which is designed to dissipate the plasma and vapor plume 34. The system 100 includes a roller 104 to compress together the sheets being welded, and a laser beam 106, as described previously for the system 10. The nozzle 102, the roller 104 and the laser beam 106 are all attached to a fixture 108, which moves over fixed work pieces during the welding operation, as will be discussed further below. The rest of the details shown in FIG. 4 are unimportant to the discussion of the invention. These details are shown simply because FIG. 4 is taken from a design of a system which has been built and tested, and shown to be effective in improving weld quality when laser welding zinc coated sheets.

The nozzle 102 discharges a continuous flow of a shielding gas 110 during the welding operation. As discussed above, the shielding gas 110 is not intended to create an inert environment around the molten pool 30. Rather the shielding gas 110 from the nozzle 102 is designed to actually dissipate or blow away the plasma and vapor plume 34 and prevent the reaction with the molten pool 30 which causes the blowhole, spatter and porosity problems discussed above. In order to achieve the stabilization of the molten pool 30, the nozzle 102 must be designed to establish certain parameters in the flow of the shielding gas 110. The configuration of the nozzle 102 which is required in order to establish an effective flow of the shielding gas 110 is shown in the following figures and discussed below.

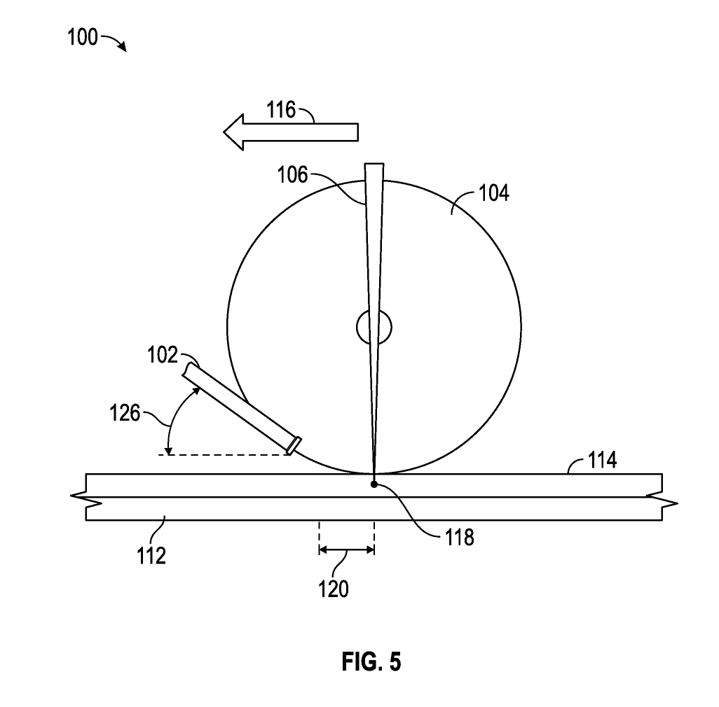

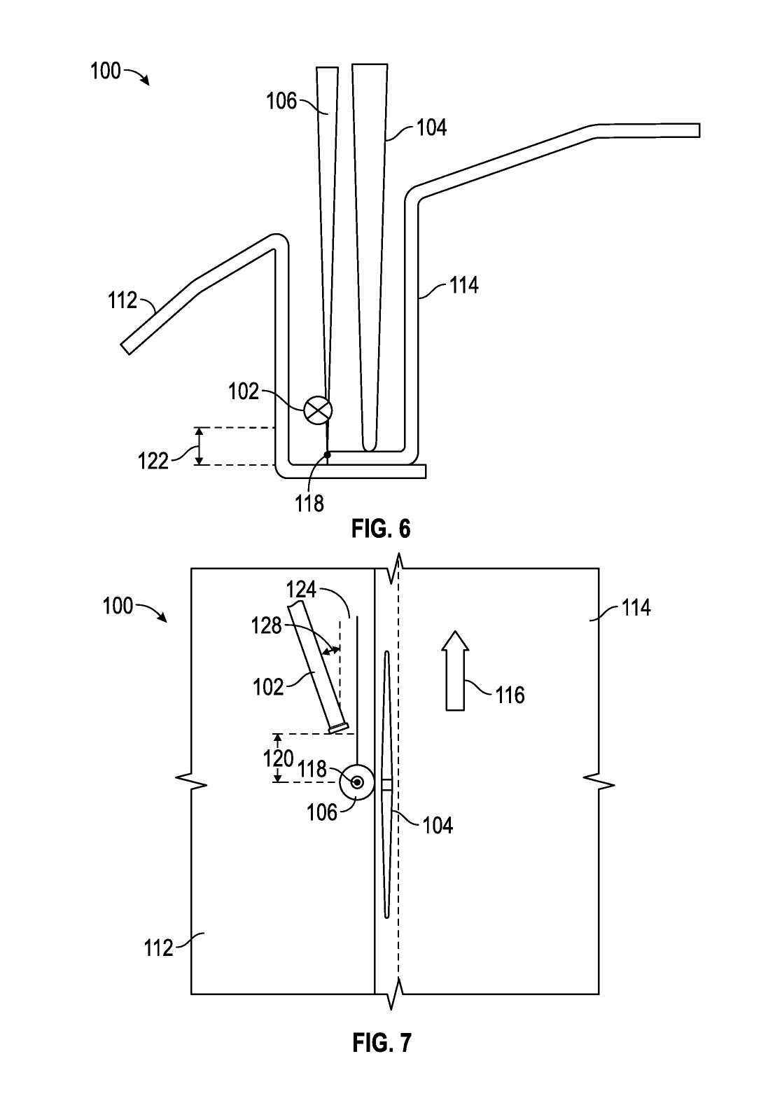

FIGS. 5, 6 and 7 are simplified side-view, end-view and top-view illustrations, respectively, of the welding system 100 of FIG. 4. Included in FIGS. 5-7 are the nozzle 102, the roller 104 and the laser beam 106 shown in FIG. 4. Also included are a first work piece 112 (lower sheet) and a second work piece 114 (upper sheet). In FIG. 6, the work pieces 112 and 114 are shown as a body side panel (112) and a roof panel (114) for an automotive application, where the nozzle 102, the roller 104 and the laser beam 106 can all reach down into the channel formed between the work pieces 112 and 114. The welding system 100 can be used effectively in edge welding applications with virtually any work piece shape—from flat sheets to the highly contoured work piece shapes shown in FIG. 6.

In FIGS. 5 and 7, an arrow 116 shows the direction of motion of the fixture 108—including the nozzle 102, the roller 104 and the laser beam 106—relative to the stationary work pieces 112 and 114. In FIGS. 5 and 7, the nozzle 102 is shown located in a leading position, where the nozzle 102 is ahead of the laser beam 106 and is blowing the shielding gas 110 “backwards”. The nozzle 102 can also be located in a trailing position (not shown), where the nozzle 102 is following the laser beam 106 and is blowing the shielding gas 110 “forward”. The system 100 has been built, tested, and shown to be effective in improving weld quality in both of these configurations.

Positioning and orientation of the nozzle 102 relative to the spot where the laser impinges the work pieces 112 and 114—shown as point 118—are important. A fore/aft distance 120 (shown in FIGS. 5 and 7) is the distance from the tip of the nozzle 102 to the weld point 118. The fore/aft distance 120 should be in the range of 0-20 mm in order to be most effective in dissipating the plasma and vapor plume 34, with a preferred range of 8-12 mm. As discussed above, the nozzle 102 can be in a leading position or a trailing position relative to the laser beam 106. The fore/aft distance 120 can thus be established either ahead of or behind the weld point 118, in the ranges described above.

A vertical distance 122 (shown in FIG. 6) is the distance the nozzle 102 is above the weld point 118. The vertical distance 122 should be in the range of 2-20 mm in order to be most effective in dissipating the plasma and vapor plume 34, with a preferred range of 6-12 mm. A lateral offset 124 (shown in FIG. 7) is the side-to-side distance of the centerline of the nozzle 102 relative to the weld point 118. The lateral offset 124 should be in the range of +/−6 mm in order to be most effective in dissipating the plasma and vapor plume 34, with a preferred range of +/−1 mm. That is, the preferred configuration is for the nozzle 102 to be positioned directly above the weld seam.

A side-view angle 126 (shown in FIG. 5) is the angle of the nozzle 102 relative to horizontal. The side-view angle 126 should be in the range of 3-86 degrees in order to be most effective in dissipating the plasma and vapor plume 34, with a preferred range of 30-60 degrees. The side-view angle 126, the vertical distance 122 and the fore/aft distance 120 are interdependent in that the aiming location of the shielding gas 110 is important. In the configuration where the nozzle 102 is in a leading position, it is preferred that the nozzle 102 aims the shielding gas 110 directly at the weld point 118—not ahead of the point 118, and not behind it. In this configuration, the relationship between the side-view angle 126, the vertical distance 122 and the fore/aft distance 120 is such that the tangent of the side-view angle 126 is equal to the quotient of the vertical distance 122 and the fore/aft distance 120. That is:

$$tan ( angle 126 ) = \frac{distance 122}{distance 120} \qquad ( 1 )$$

In the configuration where the nozzle 102 is in a trailing position, it is preferred that the nozzle 102 aims the shielding gas 110 at the weld point 118 or up to 8 mm ahead of the weld point 118—with a preferred aiming lead distance range of 0-3 mm ahead of the point 118. Here again, the side-view angle 126 can be established as a function of the vertical distance 122, the fore/aft distance 120 and the aiming lead distance.

A top-view angle 128 (shown in FIG. 7) is the angle of the nozzle 102 relative to the direction of travel of the fixture 108 as seen from above. That is, the top-view angle 128 determines whether the flow of the shielding gas 110 has a significant lateral component, or whether the gas flow is essentially aimed along the weld seam. The top-view angle 128 can be established within a suitable range of values, as long as the flow of the shielding gas 110 is aimed at or near the weld point 118. In the configuration where the lateral offset 124 is near zero, the top-view angle 128 should be in the range of +/−10 degrees in order to be most effective in dissipating the plasma and vapor plume 34, with a preferred range of +/−5 degrees. In other words, if the lateral offset 124 is zero, then the top-view angle 128 is also zero. If the lateral offset 124 is not zero, then the top-view angle 128 is established to aim the shielding gas 110 at the weld point 118 in the top view.

Nozzle airflow characteristics are also very important. If the velocity of the shielding gas 110 is too low, the plasma and vapor plume 34 will not be suppressed sufficiently, and reaction of the zinc vapor with the molten pool 30 will still occur. The velocity of the shielding gas 110 should be in a range of 10-200 meters/second (m/s) in order to be most effective in dissipating the plasma and vapor plume 34, with a preferred range of 30-120 m/s. These velocity ranges are significantly higher than the velocity of gases typically introduced in other welding apparatuses, where low-velocity gas is used to create an inert environment around the weld are, for example.

Along with velocity, mass flow rate of the shielding gas 110 is also important in suppressing the plasma and vapor plume 34. That is, shielding gas velocity may be within the ranges described above, but if the mass flow rate is too low, the shielding gas 110 will not be effective in blowing away the plasma and vapor plume 34. Depending on the type of gas used, the mass flow rate of the shielding gas 110 should be in a range of 10-660 grams/second (g/s) in order to be most effective in dissipating the plasma and vapor plume 34.

The nozzle 102 can have any cross-sectional area and shape which are suitable for the gas velocity and flow rate ranges discussed above, and also suitable for fitting between any work piece obstructions in the welding application. A circular nozzle cross-section may be used, with a diameter in a range of 2-20 mm, and a preferred diameter range of 8-12 mm. A rectangular nozzle cross-section may also be used, with a width ranging from 5-15 mm and a height ranging from 1-5 mm. The nozzle 102 is connected to a supply tube or pipe, which in turn is connected to a compressed gas source through a regulator. The supply tube, regulator and gas source are not shown in the figures, as they would be clearly understood by one skilled in the art.

As mentioned previously, the shielding gas 110 can be air, as the purpose of the shielding gas 110 is to suppress or blow away the plasma and vapor plume 34, not to create an inert environment around the weld area to prevent the zinc vapor from reacting with the molten pool 30. The ready availability and low cost of compressed air make the system 100 particularly attractive. Other gases, including nitrogen and argon, may also be used effectively as the shielding gas 110.

The apparatus 100 of FIGS. 4-7 may also be effectively used for laser welding of other metals besides zinc coated steel. For example, the laser welding apparatus 100 may be used for vapor plume dissipation when edge welding aluminum, where the plasma and vapor plume 34 is caused by a coating such as titanium-zirconium on the aluminum sheet, or by other elements such as magnesium which are contained in aluminum alloy. Regardless of the type of metal being welded or the source of the plasma and vapor plume 34, the laser welding apparatus 100 with a high flow rate of the shielding gas 110 can be used for effective vapor plume dissipation.

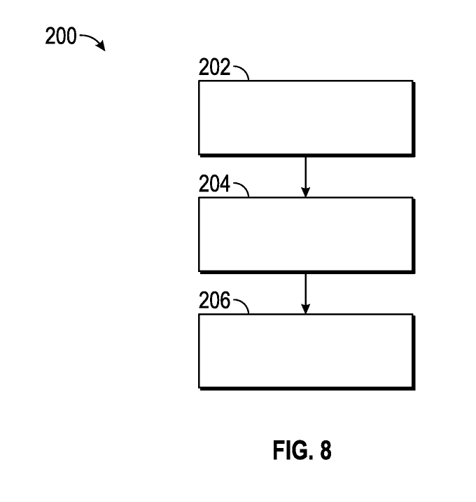

FIG. 8 is a flowchart diagram 200 of a method for welding zinc coated steel which includes applying a flow of gas to the weld area to suppress the fumes and stabilize the molten pool 30. At box 202, a laser welding apparatus 100 is provided, where the apparatus 100 includes at least a laser beam 106 for edge welding two sheets (112, 114) of zinc coated steel and a nozzle 102 for providing a flow of a shielding gas 110 to a weld area. At box 204, the flow of the shielding gas 110 is provided, and at box 206, the laser welding operation is started. As discussed above, the flow of the shielding gas 110 is provided with a velocity of at least 10 m/s and a mass flow rate of at least 10 g/s—sufficient to dissipate the plasma and vapor plume 34, prevent reaction of the zinc vapor with the molten pool 30, and avoid problems with blowholes, spatter and porosity.

All of the configuration parameters—including positioning, orientation, sizing and flow parameters—discussed above with respect to the system 100 shown in FIGS. 4-7, are applicable to the method of the flowchart diagram 200.

Using the techniques described above, problems which are typically associated with edge welding of zinc coated sheets can be avoided. By eliminating blowholes, spatter and porosity, weld quality is improved, and costly additional finishing operations are avoided. The improved weld quality also opens up edge welding to applications where spot welding or brazing were traditionally used, which in turn lowers cost and offers more design flexibility. All of these benefits result in lower cost and higher quality, which are good for both the automotive manufacturer and the customer.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. An apparatus for suppressing a plasma and vapor plume when laser welding zinc coated sheets, said apparatus comprising:
a fixture upon which other components of the apparatus are mounted, where the fixture moves along a direction of motion and the sheets which are being welded are stationary;
a welding laser mounted to the fixture and directed to a weld point, where the weld point is a point where the laser impinges the sheets which are being welded; and
a shielding gas provision system mounted to the fixture, said shielding gas provision system including a nozzle, where the nozzle provides a flow of a shielding gas, and where the flow of the shielding gas has a velocity of at least 10 meters/second and a mass flow rate of at least 10 grams/second, and during welding the flow of the shielding gas dissipates the plasma and vapor plume and prevents the plume from adversely affecting weld quality.

2. The apparatus of claim 1 wherein the flow of the shielding gas has a velocity in a range of 30-120 meters/second.

3. The apparatus of claim 2 wherein the flow of the shielding gas has a mass flow rate in a range of 10-660 grams/second.

4. The apparatus of claim 1 wherein the nozzle is positioned ahead of the welding laser relative to the direction of motion.

5. The apparatus of claim 4 wherein the nozzle is positioned in a range of 8-12 mm ahead of the welding laser and in a range of 6-12 mm above the weld point, and the nozzle is oriented to direct the flow of the shielding gas directly at the weld point.

6. The apparatus of claim 1 wherein the nozzle is positioned behind the welding laser relative to the direction of motion.

7. The apparatus of claim 6 wherein the nozzle is positioned in a range of 8-12 mm behind the welding laser and in a range of 6-12 mm above the weld point, and the nozzle is oriented to direct the flow of the shielding gas at an aim point which is in a range of 0-3 mm ahead of the weld point.

8. The apparatus of claim 1 wherein the nozzle has a circular cross-section with a diameter in a range of 8-12 mm.

9. The apparatus of claim 1 wherein the shielding gas is air.

10. An apparatus for suppressing a plasma and vapor plume when laser welding zinc coated sheets, said apparatus comprising:
a fixture upon which other components of the apparatus are mounted, where the fixture moves along a direction of motion and the sheets which are being welded are stationary;
a welding laser mounted to the fixture and directed to a weld point, where the weld point is a point where the laser impinges the sheets which are being welded; and
a shielding gas provision system mounted to the fixture, said shielding gas provision system including a nozzle, where the nozzle provides a flow of air, and where the flow of air has a velocity in a range of 30-120 meters/second and a mass flow rate of at least 10 grams/second, and during welding the flow of air dissipates the plasma and vapor plume and prevents the plume from adversely affecting weld quality.

11. The apparatus of claim 10 wherein the nozzle is positioned in a range of 8-12 mm ahead of the welding laser relative to the direction of motion and in a range of 6-12 mm above the weld point, and the nozzle is oriented to direct the flow of air directly at the weld point.

12. The apparatus of claim 10 wherein the nozzle is positioned in a range of 8-12 mm behind the welding laser relative to the direction of motion and in a range of 6-12 mm above the weld point, and the nozzle is oriented to direct the flow of air at an aim point which is in a range of 0-3 mm ahead of the weld point.

13. A method for suppressing a plasma and vapor plume when laser welding zinc coated sheets, said method comprising:
providing a welding apparatus, said apparatus including a welding laser and a shielding gas provision system including a nozzle, where the welding apparatus moves along a direction of motion and the sheets which are being welded are stationary;
providing a flow of a shielding gas from the nozzle to a weld point, where the weld point is a point where the laser impinges the sheets which are being welded, and where the flow of the shielding gas has a velocity of at least 10 meters/second and a mass flow rate of at least 10 grams/second; and
laser welding the sheets, during which welding the flow of the shielding gas dissipates the plume and prevents the plume from adversely affecting weld quality.

14. The method of claim 13 wherein the flow of the shielding gas has a velocity in a range of 30-120 meters/second.

15. The method of claim 14 wherein the flow of the shielding gas has a mass flow rate in a range of 10-660 grams/second.

16. The method of claim 13 wherein the nozzle is positioned ahead of the welding laser relative to the direction of motion.

17. The method of claim 16 wherein the nozzle is positioned in a range of 8-12 mm ahead of the welding laser and in a range of 6-12 mm above the weld point, and the nozzle is oriented to direct the flow of the shielding gas directly at the weld point.

18. The method of claim 13 wherein the nozzle is positioned behind the welding laser relative to the direction of motion.

19. The method of claim 18 wherein the nozzle is positioned in a range of 8-12 mm behind the welding laser and in a range of 6-12 mm above the weld point, and the nozzle is oriented to direct the flow of the shielding gas at an aim point which is in a range of 0-3 mm ahead of the weld point.

20. The method of claim 13 wherein the shielding gas is air.
